(19) United States
(12) Patent Application Publication
(10) Pub. No.: US 2012/0160861 A1
(43) Pub. Date: Jun. 28, 2012

(54) SYSTEM FOR WRITING TO AND DISPENSING SOLID-STATE STORAGE DEVICES

(76) Inventor: Lisbeth Moreira Fletcher, La Mesa, CA (US)

(21) Appl. No.: 12/980,128

(22) Filed: Dec. 28, 2010

(51) Int. Cl. B65D 83/00; B65G 59/00

(52) U.S. Cl. 221/1; 221/199; 221/97

(57) ABSTRACT

An apparatus for writing data to and dispensing one or more of solid-state devices may comprise a write port engageable with a solid-state storage device within the one or more solid-state storage devices to write the data to the solid-state device; a chamber for holding the solid-state storage device as the solid-state storage device engages with the write port; and a transfer assembly for moving the solid-state storage device from the chamber to dispense the solid-state storage device.

### BACKGROUND OF THE INVENTION

The present invention generally relates to solid-state storage devices, and more particularly relates to apparatus and methods for writing to and dispensing solid-state storage devices.

Currently, a growing number of consumers are turning to solid-state storage devices such as thumb drives and memory cards for their computer storage needs in lieu of optical storage devices, such as CD-ROMs and DVDs, due to the increased durability, reliability, portability, and ease of use of solid-state storage devices.

Furthermore, solid-state storage devices may also allow content providers to deliver more timely and relevant content with more flexibility and lower cost as compared to traditional optical storage devices. As such, content providers such as software firms, electronic game developers, or movie studios may wish to start providing content on solid-state storage devices instead of or in addition to the optical formats they currently provide.

As can be seen, there is a need for a system for writing and dispensing solid-state storage devices

### SUMMARY OF THE INVENTION

In one aspect of the present invention, an apparatus for writing data to and dispensing one or more of solid-state devices comprises a write port engageable with a solid-state storage device within the one or more solid-state storage devices to write the data to the solid-state device; a chamber for holding the solid-state storage device as the solid-state storage device engages with the write port; and a transfer assembly for moving the solid-state storage device from the chamber to dispense the solid-state storage device.

In another aspect of the present invention, a method for writing data to and dispensing one or more solid-state devices comprises holding a solid-state storage device within the one or more solid-state devices in a chamber; engaging a write port with the solid-state storage device; writing the data by the write port to the solid-state device; and moving, by a transfer assembly, the solid-state storage device from the chamber to a retrieval bin.

These and other features, aspects and advantages of the present invention will become better understood with reference to the following drawings, description and claims.

### BRIEF DESCRIPTION OF THE DRAWINGS

FIG. 1 shows a perspective view of a solid-state storage device writer and dispenser system in accordance with an embodiment of the present invention; and

FIG. 2 shows a perspective view of the internal components of the system of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a system for writing and dispensing solid-state storage devices.

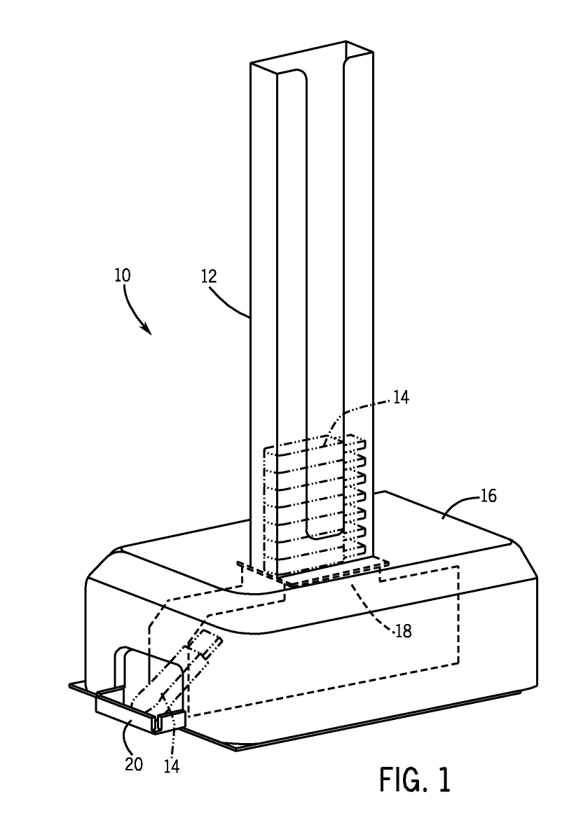

With reference to FIG. 1, a system 10 for writing and dispensing solid-state storage devices may include a hopper operably coupled to a base 16 for holding a plurality of solid-state storage devices 14. The plurality of solid-state storage devices 14 may comprise Universal Serial Bus (USB) storage devices, memory sticks, secure digital (SD) memory cards, extreme digital (xD) memory cards, micro SD memory cards, or any other suitable solid-state storage devices 14.

The plurality of solid-state storage devices 14 may be transferred from the hopper 12 into a base 16 in a predictable or regular manner for writing each of the plurality of solid-state storage devices 14. As shown in FIG. 1, the hopper 12 may be situated above the base 16, but in alternative embodiments the hopper may be situated below or beside the base 16. After writing, the solid-state storage devices 14 may be moved by a transfer assembly 18 within the base 16 to a retrieval bin 20 for dispensing the written solid-state storage device 14.

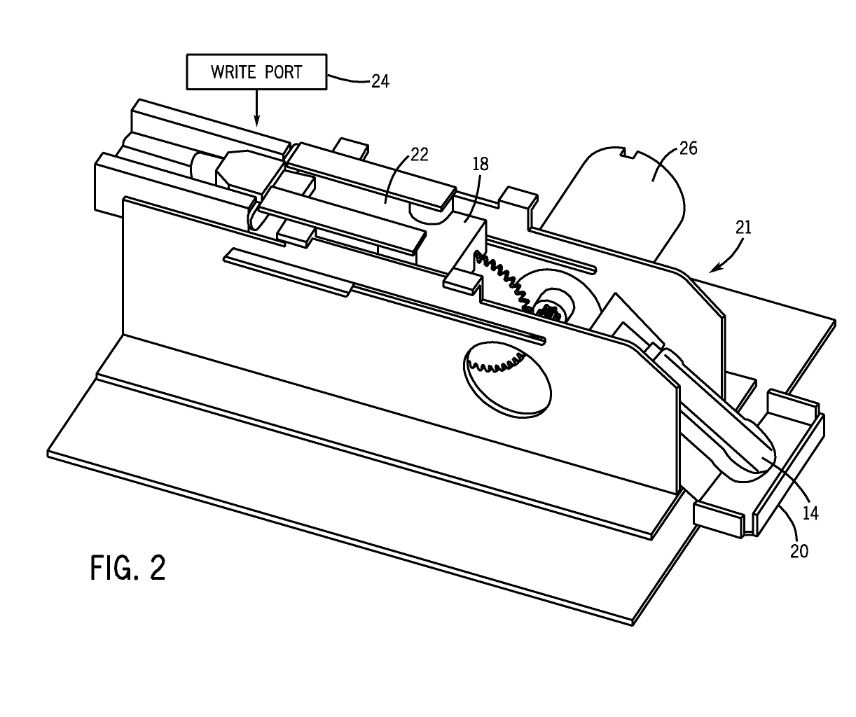

With reference to FIG. 2, a frame 21 within the base 16 of the system 10 may include an exemplary mechanism for writing and dispensing the solid-state storage devices 14. When a solid-state storage device 14 moves from the hopper 12 into the base 16, the solid-state storage device 14 may be held by a chamber 22 which may orient the solid-state storage device 14 with a write port 24.

As the solid-state storage device 14 is held in the chamber 22, the solid-state storage device 14 may engage with the write port 24 by moving towards and connecting with the write port 24. Alternatively, the write port 24 may move towards the solid-state storage device 14. The write port 24 may be connected to a computer and the write port 24 may transfer data from the computer and write that data onto the write port 24. For example, the computer connected to the write port 24 may sense the solid-state storage device 14 as it engages with the write port 24 and may automatically start to write data to the solid-state storage device 14. Further, the computer connected to the write port 24 may also send a signal to the system 10 when the computer has finished writing data to the solid-state storage device 14, so that the system 10 knows when it is safe to disengage the solid-state storage device 14 from the write port 24.

Once the writing of the solid-state storage device 14 has finished, the solid-state storage device 14 may be disengaged from the write port 24. A transfer assembly 18 driven by a motor 26 may then move the solid-state storage device 14 from the chamber 22 to the retrieval bin 20 to dispense the solid-state storage device 14. In alternative embodiments of the present invention, vacuum or the friction between the write port 24 and the solid-state storage device 14 may be used in place of the transfer assembly 18 to move the solid-state storage device 14 to the retrieval bin 20.

Once the solid-state storage device 14 has been moved from the chamber 22 by the transfer assembly 18 or by other means, another solid-state storage device 14 may be transferred from the hopper 12 into the chamber 22 for writing. Thus, the writing and dispensing of the solid-state storage devices 14 may be automated by the system 10.

It should be understood, of course, that the foregoing relates to exemplary embodiments of the invention and that modifications may be made without departing from the spirit and scope of the invention as set forth in the following claims.

We claim:

1. An apparatus for writing data to and dispensing one or more of solid-state devices, comprising:
a write port engageable with a solid-state storage device within the one or more solid-state storage devices to write the data to the solid-state device;
a chamber for holding the solid-state storage device as the solid-state storage device engages with the write port; and
a transfer assembly for moving the solid-state storage device from the chamber to dispense the solid-state storage device.

2. The apparatus of claim 1, further comprising a hopper for containing the one or more solid-state storage devices.

3. The apparatus of claim 2, further comprising a retrieval bin for dispensing the one or more solid-state storage devices, wherein the transfer assembly is operable to move the one or more solid-state storage devices from the chamber to the retrieval bin.

4. The apparatus of claim 3, further comprising a motor for driving movement of the transfer assembly.

5. The apparatus of claim 4, wherein the write port is moveable to engage with the solid-state storage device.

6. A method for writing data to and dispensing one or more solid-state devices, comprising:
holding a solid-state storage device within the one or more solid-state devices in a chamber;
engaging a write port with the solid-state storage device;
writing the data by the write port to the solid-state device; and
moving, by a transfer assembly, the solid-state storage device from the chamber to a retrieval bin.

7. The method of claim 6, further comprising containing the one or more solid-state devices within a hopper.

8. The method of claim 7, further comprising transferring the solid-state storage device from the hopper to the chamber.

9. The method of claim 6, further comprising moving the solid-state storage device to engage the write port.

10. The method of claim 6, further comprising driving the transfer assembly by a motor.
